(19) United States
(12) Patent Application Publication
(10) Pub. No.: US 2012/0017507 A1
(43) Pub. Date: Jan. 26, 2012

(54) AUTOMATED ORGANIC POLARIZED OBJECT ORGANIZATION

(75) Inventor: KENNETH DEWANE OWENS, JR., Eureka, CA (US)

(73) Assignee: COGNISENSE LABS, INC., Eureka, CA (US)

(21) Appl. No.: 12/840,315

(22) Filed: Jul. 21, 2010

(51) Int. Cl. A01C 14/00; G05B 19/04

(52) U.S. Cl. 47/1.1 P; 47/58.1 R; 700/253; 901/30

(57) ABSTRACT

A method and apparatus for organizing multiple organic polarized objects are provided. In some embodiments, an organic polarized object is spread on a conveyor belt when the organic polarized object is transported from organic polarized object storage. An inventory control system is updated when a count of organic polarized object is communicated. The apparatus includes an image processor to identify the size, shape, location and orientation of organic polarized objects and to communicate this information to a robotic end effector. The organic polarized object is automatically filled in slot of a tray or stuck onto pins through a robotic end effector. The tray may be covered with a basket and flipped. The apparatus includes a calibration module to align the coordinate systems of an image capture device and a robotic end effector. The apparatus also includes organic polarized object sorter machine, basket flipping machine and a nutrient filling machine.

### FIELD OF TECHNOLOGY

This disclosure relates generally to robotic technology and, more particularly, to automated organic polarized object organization.

### BACKGROUND

A robotic end effector may be an electromechanical device that may have an extendable frame that can manipulate, rotate, and physically move an object. The robotic end effector may be programmable and may have similar functions to that of a human arm. The links of such a robotic end effector may be connected by joints that may allow rotational motion (such as in an articulated robot) and/or translational (linear) displacement. The links of the manipulator may be considered to form a kinematic chain. One end of the kinematic chain of the robot arm may be called an end effector. The robotic end effector may be analogous to the human hand. The robotic end effector may be designed to perform any desired task such as welding, gripping, spinning etc., depending on an application. For example, the robotic end effector may be used in automotive assembly lines to perform a variety of tasks such as welding, part rotating, and positioning objects during assembly.

The robotic end effector may be designed to perform repetitive tasks on uniform objects. The robotic end effector may damage certain objects, because it may grip too tightly. Conventionally non uniform objects that are delicate are manually positioned so as to prevent damaging the non uniform objects, for example, plant bulbs are manually planted. Manually positioning non uniform objects has several disadvantages including lack of efficiency and dependence on manual labor. Hence there is an unmet need for automated organization of non uniform objects.

### SUMMARY

A method and an apparatus disclosed herein address the above stated need for automated organization of non uniform objects including, for example, organic polarized objects such as plant bulbs.

In one aspect, the method includes spreading an organic polarized object in a single file on the conveyor belt when the organic polarized object is transported from organic polarized object storage. The method also includes updating an inventory control system through a wireless communication system when a count of the organic polarized object is communicated. The method further includes automatically filling the organic polarized object in a slot of a tray through a robotic end effector until a maximum fill capacity of the tray is achieved, wherein the slot is of a specific shape to receive a first end of the organic polarized object in the slot before a second end of the organic polarized object, such that the first end of the organic polarized object is oriented towards a narrow base of the slot and the second end is oriented towards a broad opening of the slot. The method furthermore includes covering the tray with a nutrient mixture, covering the tray with a basket, rotating the basket so that the organic polarized objects are correctly oriented for growing and removing the basket.

In another aspect, the apparatus includes an organic polarized object sorter machine to sort the organic polarized object in a single file on a conveyor belt. The apparatus also includes the conveyor belt to transport the organic polarized object to the robotic end effector which may place the organic polarized objects into a slot in a tray. The apparatus further includes an image capture device to record an image of one or more of a first organic polarized object and a second organic polarized object. The apparatus furthermore includes a data storage device to store a data set from the image capture device after the recording of the image. The apparatus furthermore includes a processor to calculate “n” degrees of freedom movement for the robotic end effector using a training data set. The apparatus furthermore includes a tray with a plurality of slots to hold the second organic polarized object at a specific slot. The apparatus furthermore includes a signal device to indicate that the tray has reached a maximum capacity and to prompt a change for another empty tray. The method further includes an apparatus for changing the tray orientation so that the organized polarized objects are in the correct orientation for growing.

In one or more embodiments, a hydroponic technology may be used to grow the organic polarized objects. As used herein the term hydroponics refers to a method of growing plants without soil. In these embodiments one or more essential nutrients may be introduced to the organic polarized objects through fluids (e.g., water) in the place of soil. Also, in these embodiments, the tray may contain an array of sharp pins and the robotic end effector may stick the organic polarized objects to the sharp pins. The trays may then be positioned in a liquid (e.g., water) to allow the organic polarized objects to grow when submerged in the liquid.

The methods, systems, and apparatuses disclosed herein may be implemented in any means for achieving various embodiments, and may be executed in a form of a machine-readable medium embodying a set of instructions that, when executed by a machine, cause the machine to perform any of the operations disclosed herein. Other features will be apparent from the accompanying drawings and from the detailed description that follows

### BRIEF DESCRIPTION OF THE DRAWINGS

Example embodiments are illustrated by way of example and not limited by the figures of the accompanying drawings, in which like references indicate similar elements and in which:

FIGS. 1A-1B illustrate an apparatus for automated organic polarized object organization, in accordance with one or more embodiments.

FIG. 2 illustrates a first stage during a process of automated organic polarized object organization, in accordance with one or more embodiments.

FIG. 3A-3B illustrates a second stage during the process of automated organic polarized object organization, in accordance with one or more embodiments.

FIGS. 4A-4B illustrate a third stage during the process of automated organic polarized object organization, in accordance with one or more embodiments.

FIG. 5A illustrates selection of one or more organic polarized objects for automated organization of the organic polarized objects, in accordance with one or more embodiments.

FIG. 5B is a schematic view illustrating generation of a training data set, in accordance with one or more embodiments.

FIG. 5C is a flow chart illustrating a process of comparing data of the organic polarized object with the training data set to identify if the organic polarized object possesses a desirable shape, size, location and/or orientation, in accordance with one or more embodiments.

FIG. 6 is a block diagram illustrating an organic polarized object processing system, in accordance with one or more embodiments.

FIGS. 7 is a process flow illustrating a method of automated organic polarized object organization, in accordance with one or more embodiments.

FIGS. 8A-8B is a process flow illustrating a vision based method of automated organic polarized object organization, in accordance with one or more embodiments.

Other features of the present embodiments will be apparent from accompanying Drawings and from the Detailed Description that follows.

### DETAILED DESCRIPTION OF THE INVENTION

An apparatus and a method of automated organic polarized object organization are disclosed. In the following description, for the purposes of explanation, numerous specific details are set forth in order to provide a thorough understanding of the various embodiments. It may be evident, however, to one skilled in the art that the various embodiments may be practiced without these specific details.

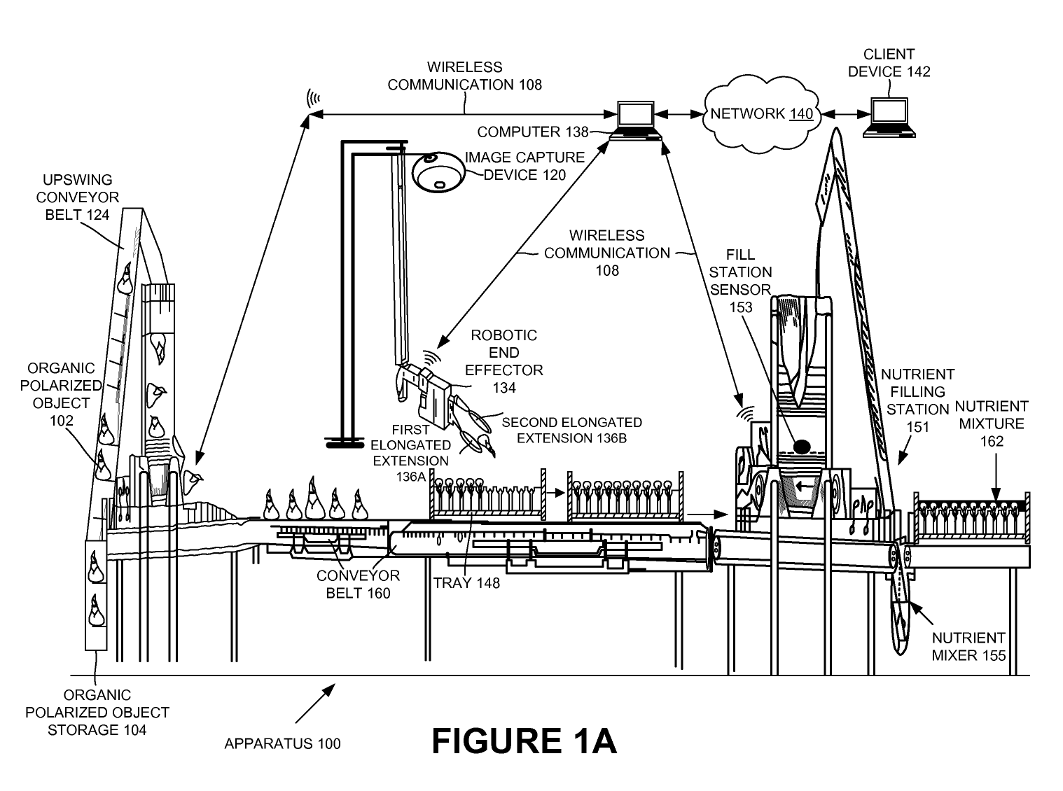

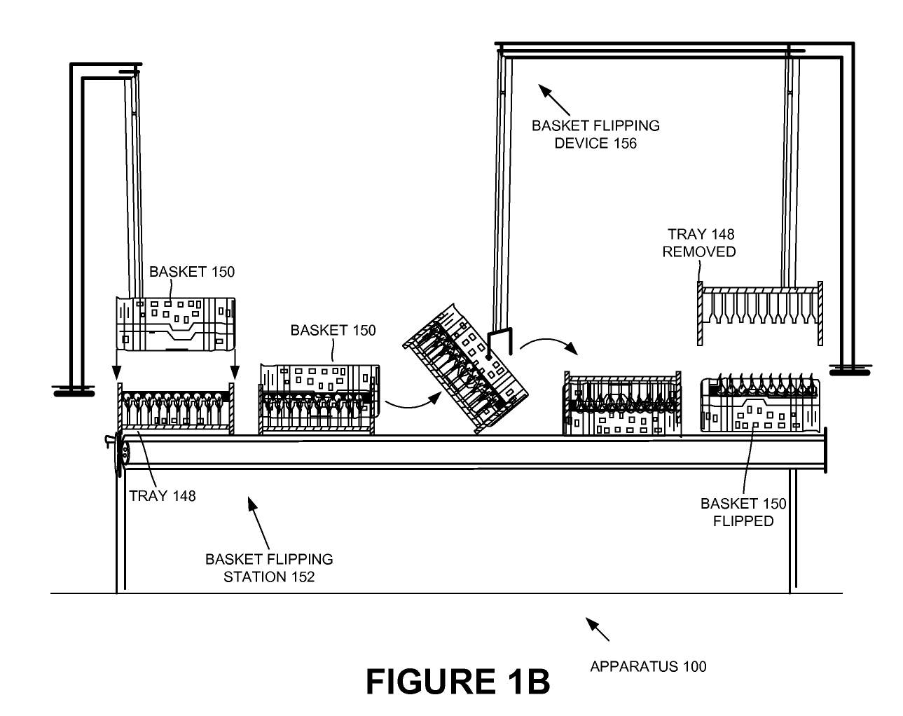

FIGS. 1A-1B illustrate an apparatus 100 for automated organic polarized object organization in accordance with one or more embodiments. For purposes of illustration, the detailed description refers to an organic polarized object; however the scope of the method, the system, and/or the apparatus 100 disclosed herein is not limited to a single organic polarized object but may be extended to include an almost unlimited number of organic polarized objects. As used herein, the term “organic polarized object” refers to any organic object of a regular or an irregular shape and form, having a proximal end and a distal end, and hence an orientation. Example of the organic polarized object 102 may include, but is not limited to, a seed, a plant bulb, a resting stage of a seed plant, a sapling, and the like.

The apparatus 100 includes an organic polarized object sorter machine to sort the organic polarized object 102 in a single file on a conveyor belt 160. The conveyor belt 160 may be used to transport one or more organic polarized objects (e.g. organic polarized object 102) from the organic polarized object sorter machine towards a robotic end effector 134. The robotic end effector 134 may be configured to fetch the organic polarized objects from the conveyor belt 160 and place the organic polarized objects into one or more slots in a tray 148. In one or more embodiments, the movement of the robotic end effector 134 may be controlled by pneumatic cylinders (not shown). The pneumatic cylinders may be attached to one or more elongated extensions (e.g., a first elongated extension 136A and a second elongated extension 136B) to hold the organic polarized objects (e.g. organic polarized object 102) to transfer the organic polarized objects into the slots and/or pins of the tray 148 at desired location and/or in a desired orientation. In one or more embodiments, the first elongated extension 136A and the second elongated extension 136B may include a sensor device (not shown) to sense the presence of the organic polarized objects. Example of the sensor device may include, but is not limited, one of a capacitive sensor, a optical sensor, a resistive sensor, an inductive sensor, and the like. In one or more embodiments, the sensor device may also relay/communicate a count of the organic polarized objects that are processed through the apparatus 100, to a data processing system (e.g. computer 138). The communication may be through a wired and/or a wireless communication. In one or more embodiments, an application may control the robotic end effector 134 and movement of the robotic end effector 134.

In one or more embodiments, the apparatus 100 also includes an image capture device 120, a data storage device, a processor, the tray 148, and a signal device. The image capture device 120 may be configured to capture an image of an organic polarized object. For example, a first image of a first organic polarized object and/or a second image of a second organic polarized object may be captured through the image capture device 120. The image capture device 120 may record the image after capturing. Example of the image capture device 120 includes, but is not limited to, a digital camera, a video camera, a probe, an optical device, an infra-red device, a biosensor, a color sensor, a heat sensor, a water sensor, and a laser device. In one or more embodiments, the captured image may be transferred to a data storage device. The data storage device may store a data set from the image capture device 120 after the recording of the image. The processor may calculate “n” degrees of freedom movement for the robotic end effector 134 using a training data set. The “n” degrees of freedom of movement may include, but is not limited to a moving up and down in heaving, a moving left and right in swaying, a moving forward and backward in surging, a tilting forward and backward in pitching, a turning left and right in yawing, a full axis motion in 360 degree rotation, a tilting side to side in rolling, and a movement along one or more of x, y, and z coordinate axes. Further, the processor may be configured to algorithmically calculate a dimension data from the captured images (e.g., the first image and the second image). Examples of the dimension data may include, but is not limited to, one or more of a width, a depth, a length, a distance, intensity, a curvature, a surface area, a volume, a narrow field, a broad field, edges, center, and an angle.

The tray 148 may include one or more slots and/or pins to hold the organic polarized objects (e.g. the first organic polarized object 102) at specific slots/pins. In one or more embodiments, the signal device may be configured to indicate that the tray 148 has reached a maximum capacity and may prompt a change for another empty tray. In one or more embodiments the tray 148 may be a part of a large automated assembly system. In one or more embodiments, the tray 148 may be made of one or more of a biodegradable material, a plastic material, a reusable material, and/or an array of sharp pins for holding the organic polarized objects.

Also illustrated in FIG. 1A is a nutrient mixture filling station 151. The nutrient mixture filing station 151 may fill a nutrient mixture 162 into the tray 148 filled with the organic polarized objects. The nutrient mixture 162 may be stored in a nutrient mixer 155. In one or more embodiments, a fill station sensor 153 coupled to the nutrient filling station 151 may communicate one or more of a level of nutrient mixture 162 in the station, change of the tray 148, and a count for an inventory control system to the data processing system (e.g. computer 138) through a wireless communication 108 or a wired communication. The inventory control system may keep track of a number of organic polarized objects used, a number of trays filled, a number of organic polarized objects not selected, a level of the nutrient mixture 162 and a number of organic polarized objects left in the organic polarized object storage 104. The wireless communication system 108 may be designed to include one or more of a Bluetooth, a Zigbee, a WiFi, a WiMax, a PoE, and a Wibree interface. FIG. 1B illustrates a basket flipping station 152 of apparatus 100 of FIG. 1A, in accordance with one or more embodiments. In one or more embodiments, as illustrated in FIG. 1B, the tray 148 filled with the organic polarized objects and the nutrient mixture 162 may be a covered with a basket 150 at the basket flipping station 152. The basket 150 may then be flipped over at the basket flipping station 152 through a basket flipping device 156. The tray 148 may then be removed from the flipped basket 150 containing the organic polarized objects covered with the nutrient mixture 162 as illustrated in FIG. 1B. In one or more embodiments, the tray 148 may be removed through the basket flipping device 156. In one or more embodiments, after removing the tray 148, additional nutrient mixture 162 may be added to cover the organic polarized objects.

In one or more embodiments, personnel may be updated about a status of an inventory item. Examples of the inventory item may include, but is not limited to the organic polarized object 102, the nutrient mixture 162, the tray 148 and the basket 150. Updating the personnel may be conducted via one or more communication techniques including, for example, a cell phone, a PDA and a computer.

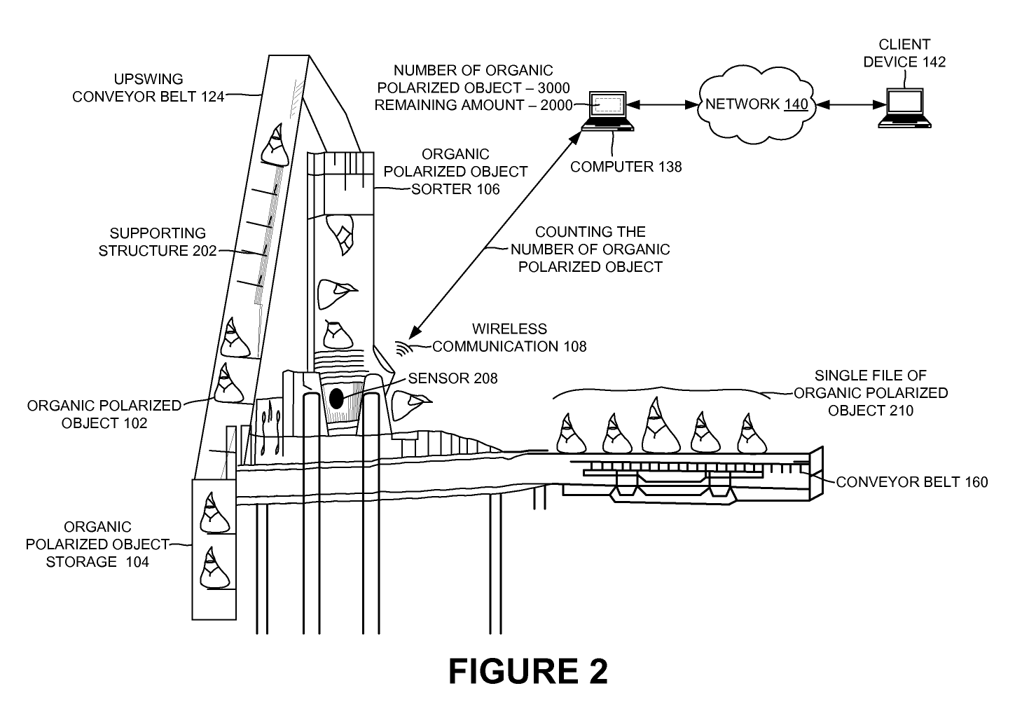

FIG. 2 illustrates a first stage during a process of automated organic polarized object organization, in accordance with one or more embodiments. During the first stage, one or more organic polarized objects may be transferred from the organic polarized object storage 104 to an organic polarized object sorter 106 through an upswing conveyor belt 124. Each organic polarized object 102 may be positioned on a supporting structure 202 on the upswing conveyor belt 124. The arrival of each of the organic polarized objects at the organic polarized object sorter 106 may be sensed through a sensor 208 and may be communicated to a data processing system (e.g. computer 138). The communication may be through a wireless communication 108 and/or a wired communication. The data processing system may count the number of organic polarized objects arriving at the organic polarized object sorter 106. In one or more embodiments the data processing system may update a database based on the counting. In one or more embodiments the data processing system may communicate the number of the organic polarized objects to a client device 142 through a network 140. The network 140 may include, but is not limited to, a local area network, a wide area network, a wired network, a wireless network, a mobile communication network, and the like. Examples of the client device 142 includes, but is not limited to a portable computing device, a laptop, a desktop, a mobile communication device, a personal digital assistant, and an electronic communication device.

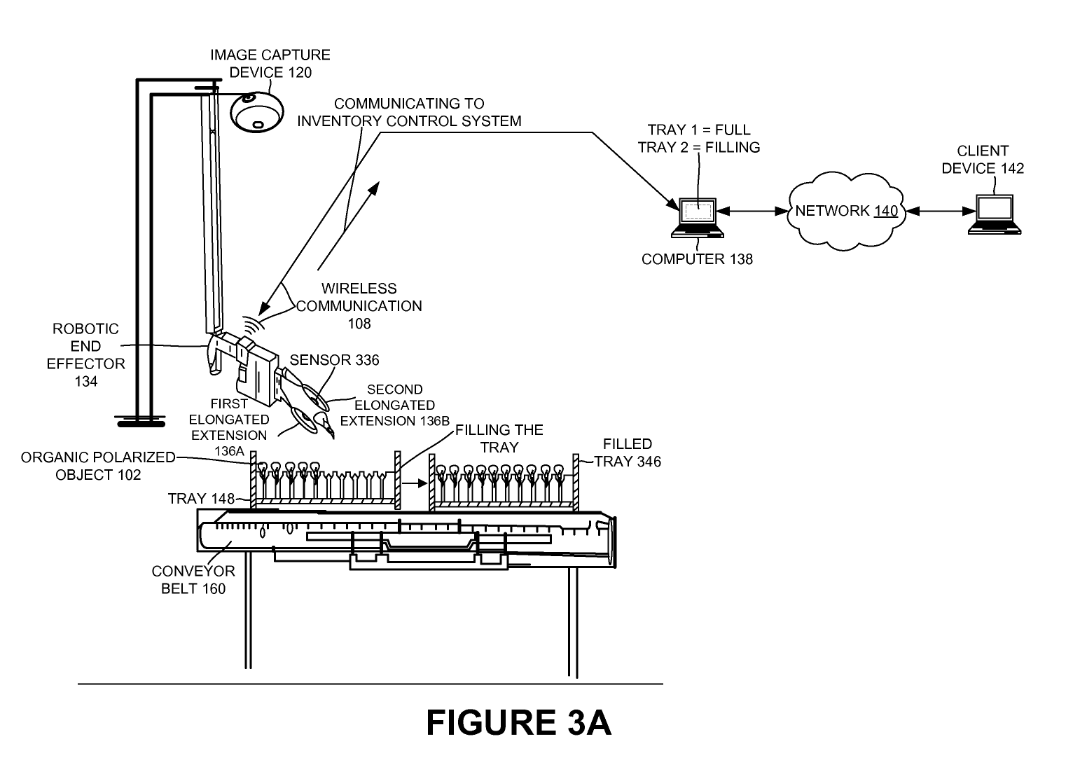

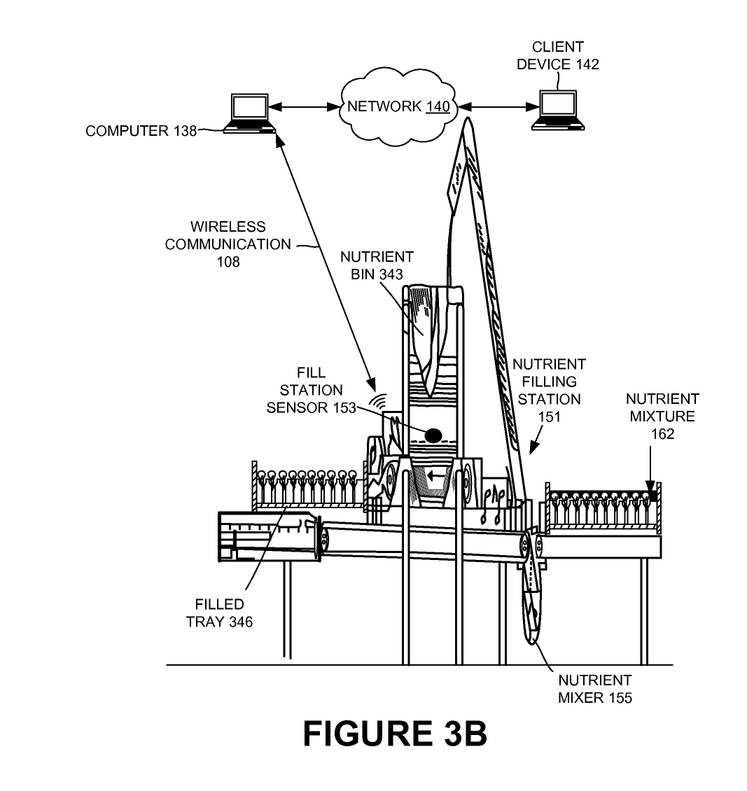

FIG. 3A-3B illustrates a second stage during the process of automated organic polarized object organization, in accordance with one or more embodiments. During the second stage, one or more organic polarized objects can be sorted through a robotic end effector 134 for organizing in one or more slots and/or pins of a tray 148. The robotic end effector 134 may be trained to automatically sort the organic polarized objects using a training data set. In one or more embodiments, the training data set may include information (e.g., coordinate information, dimension information) that can be used for training and executing certain functionalities through systems such as a robotic vision system. In an example embodiment, the training data set described herein may be used for generating commands or providing machine instructions for the robotic end effector 134 to perform one or more tasks. In one or more embodiments, an image of the organic polarized object 102 may be captured using the image capture device 120. The image capture device 120 may be coupled to the robotic end effector 134. In one or more embodiments the captured image may be transmitted to the data processing system (e.g. computer 138) for further processing. Alternatively, in one or more embodiments further processing may be performed within the robotic end effector 134.

The captured image may be processed to obtain an image data. The image data may include, but is not limited to, a width, a depth, a length, a distance, intensity, a curvature, a surface area, a volume, a narrow field, a broad field, edges, center, an angle, and the like. The image data may be used to create a data set for the organic polarized object 102. The data set may be compared with the training data set to identify the organic polarized objects (e.g. the organic polarized object 102) and/or a precise location, orientation, shape, and/or size data of the organic polarized objects. If the comparison yields a positive result indicating that the location, orientation and/or size of the organic polarized objects matches one or more specifications including a specific shape, a specific size, specific location, and/or specific orientation, then the organic polarized object 102 may be selected and fetched from the conveyor belt 160 using the robot end effector 134. In one or more embodiments, if the comparison yields a negative result, then the organic polarized object 102 may be recycled for future processing. In one or more embodiments, on selection, the organic polarized object 102 may be secured between a first elongated extension 136A and a second elongated extension 136B of the robotic end effector 134 to grasp the organic polarized object 102. After securing, the organic polarized object 102 may be positioned in one of the slots and/or pins of the tray 148.

In one or more embodiments, a data regarding the tray 148 being filled, a number of available slots in the tray 148 being filled, and/or a number of trays filled may be sensed through the image capture device 120 and the data may be communicated to the data processing system through the wireless/wired communication system. When the tray 148 may be completely filed, a filled tray 346 may be obtained and the filled tray 346 may be covered with a nutrient mixture 162 at the nutrient filling station 151. In one or more embodiments, the filled tray 346 may be partially covered with the nutrient mixture 162 at the nutrient filing station 151. In one or more embodiments, the nutrient mixture 162 may be transported through a duct from the nutrient mixer 155 operatively coupled to the nutrient filling station 151, to a nutrient bin 343. The filled tray 346 (filled with the organic polarized objects) to be filled with the nutrient mixture 162 may be positioned below the nutrient bin 343 through the conveyor belt 160. The nutrient mixture 162 may be dispensed into the filled tray 346 from the nutrient bin 343 to partially or fully fill the tray 148 with the nutrient mixture 162 as illustrated in FIG. 3B.

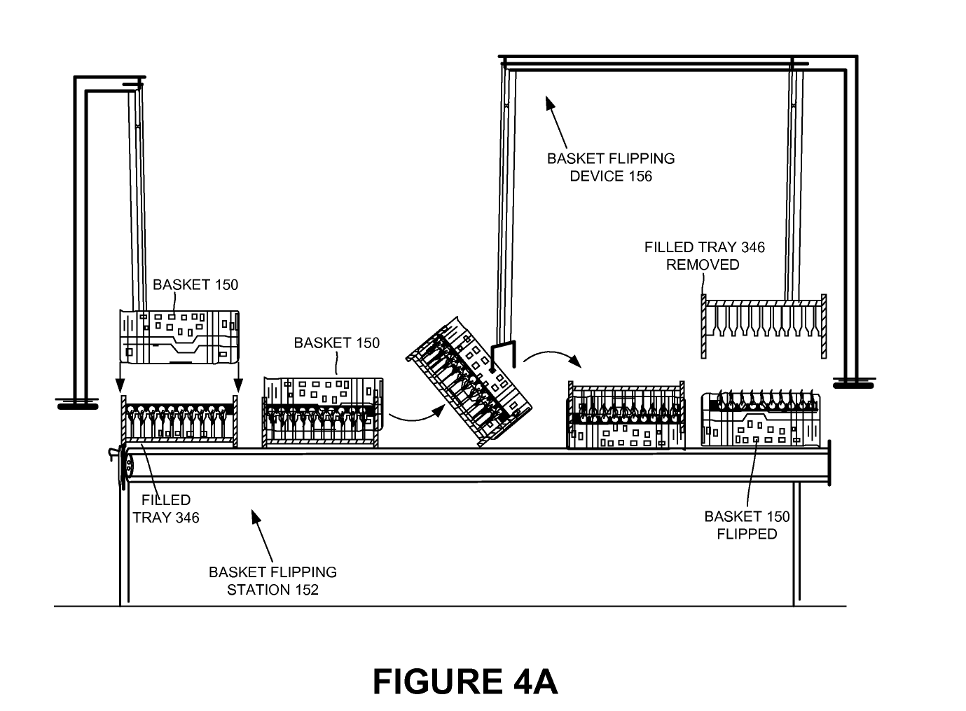

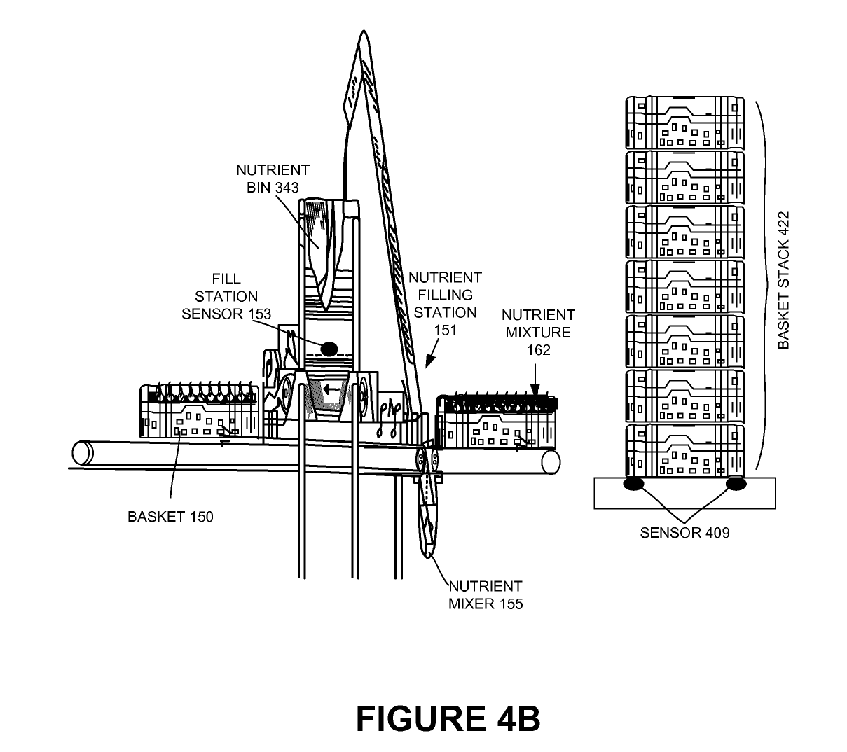

FIGS. 4A-4B illustrate a third stage during the process of automated organic polarized object organization, in accordance with one or more embodiments. During the third stage, the filled tray 346 containing the organic polarized objects covered with the nutrient mixture 162 may be covered with the basket 150. One or more dimensions of the basket 150 may match one or more dimensions of the filled tray 346. In one or more embodiments, the filled basket 150 may be flipped at a basket flipping station 152 through a basket flipping device 156 so as to correctly orient the organic polarized objects for growing as illustrated in FIG. 4A. The basket 150 containing the filled tray 346 with the organic polarized objects may then have the tray 346 removed through the basket flipping device 156 or any other device. In one or more embodiments, the basket 150 containing the organic polarized object 102 with the nutrient mixture 162 may be further filled with nutrient mixture 162 and stacked in a vertical form and/or a horizontal form on a platform to form a basket stack 422 as illustrated in FIG. 4B. The basket stack 422 may be stored in a cold storage facility for a length of time. Then the basket stack 422 may be transported to a growing area. In one or more embodiments, the fill station sensor 153 senses change of the basket 150, and/or a count for an inventory control system and communicates the sensed change of the basket 150, and the sensed count for an inventory control system to the data processing system. A sensor 409 may sense the number of baskets stacked together to form the basket stack 422. In one or more embodiments, the nutrient mixture 162 may be added to the organic polarized objects after flipping the basket over and removing the tray 346. The flipped basket containing the organic polarized objects may be transported to the nutrient filing station 151 through the conveyor belt 160.

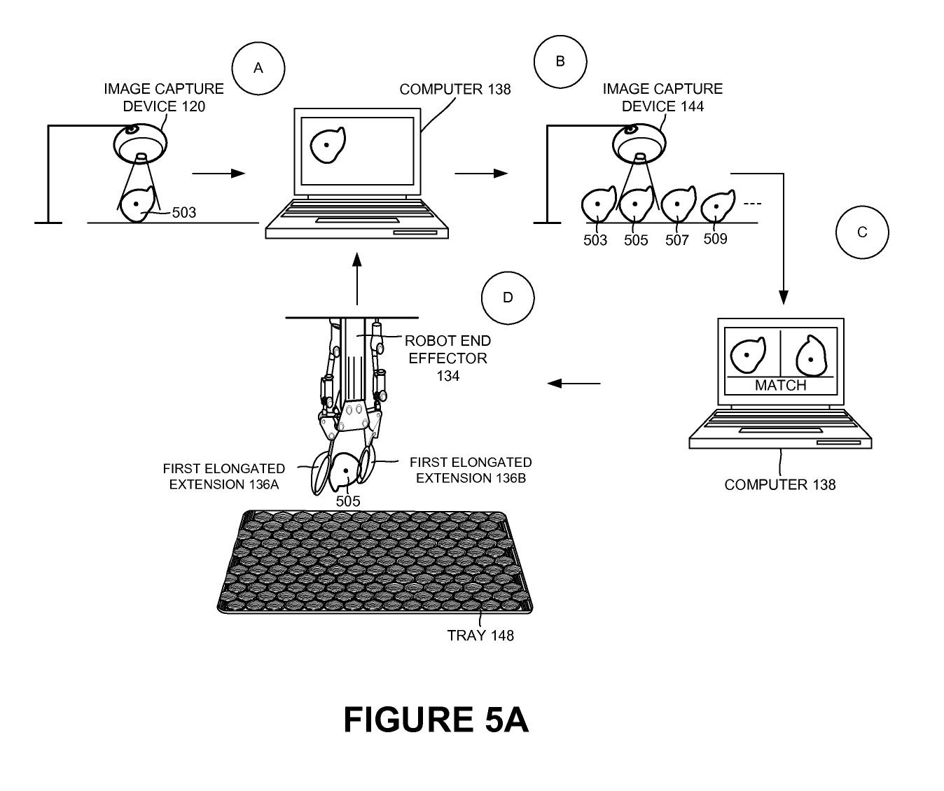

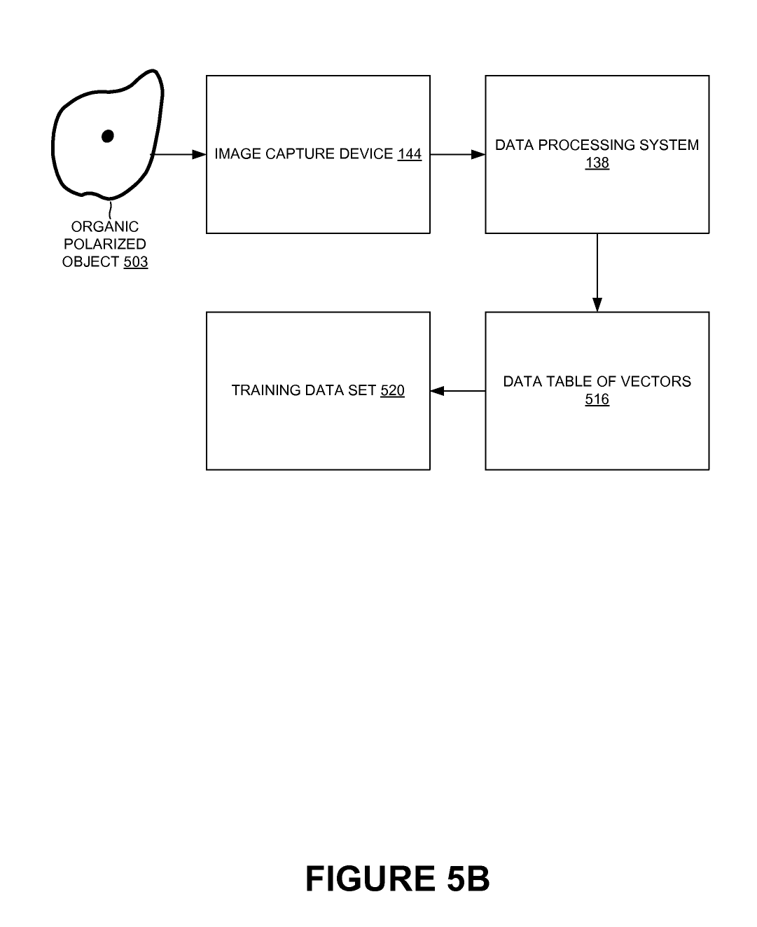

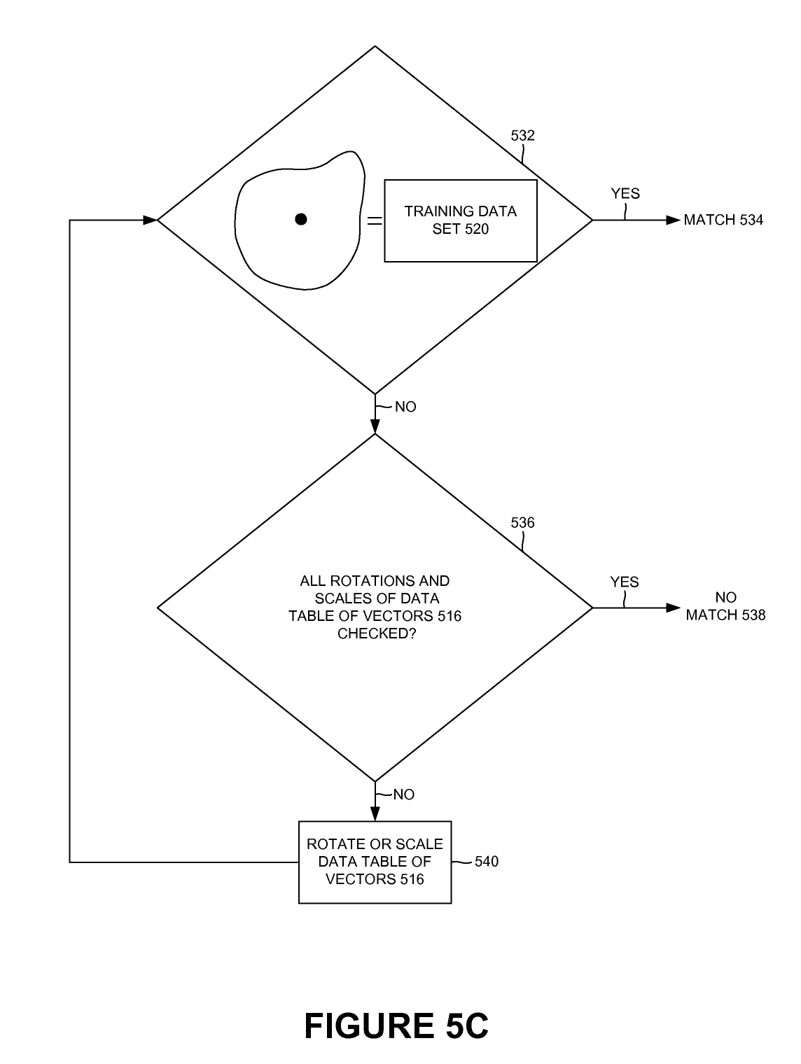

FIG. 5A illustrates selection of one or more organic polarized objects for automated organization of the organic polarized objects, in accordance with one or more embodiments. As illustrated in FIG. 5A, at step A, a first image of a first organic polarized object 503 is captured through the image capture device 120. The captured first image is processed via a data processing system (e.g. computer 138) to determine a first image data. A first dimension data of the first organic polarized object 503 may be calculated based on the first image data. The first dimension data may be algorithmically calculated. The first dimension data includes, but is not limited to, one or more of a width, a depth, a length, a distance, intensity, a curvature, a surface area, a volume, a narrow field, a broad field, edges, center and an angle. In one or more embodiments, a data table of vectors may be generated from the first dimension data of organic polarized object 503. In one or more embodiments, a training data set may be formed by transforming (e.g., skewing, rotating, scaling) the data table of vectors of the first organic polarized object 503. The training data set may determine a desirable shape, size, location, and/or orientation of one or more organic polarized objects to be selected from among the organic polarized objects for positioning in the tray 148.

Further, at step B, a second image of a second organic polarized object 505 may be captured using the image capture device 120. A second image data of the second organic polarized object 505 may be computed using the captured second image. Further, a second dimension data may be computed based on the second image data through a processor coupled to the data processing system (e.g. computer 138). At step C, the training data set may be compared to the second dimension data through the processor to identify the shape, size, location and/or orientation of the second organic polarized object. On comparison, if the second organic polarized object 505 possesses the desirable shape, size, location and/or orientation, the processor may transmit a command to the robotic end effector 134 to select the second organic polarized object 505 to be positioned in the tray 148. In one or more embodiments, at step D, the robotic end effector 134 secures the second organic polarized object 505 between a first elongated extension 136A and a second elongated extension 136B and positions it in the tray 148. Similarly, the third organic polarized object 507 may be selected owing to suitability of shape, size and may be positioned in the tray 148 by the robotic end effector 134. Further, if the shape, size of one or more organic polarized objects (e.g. third organic polarized object 507) is not desirable, the organic polarized objects may be rejected or recycled for further processing.

FIG. 5B is a schematic view illustrating generation of a training data set 520, according to one or more embodiments. As described above, in one or more embodiments, an image of the first organic polarized object 503 may be captured using the image capture device 120 and communicated to the data processing system (e.g., computer 138). In one or more embodiments, a data table of vectors 516 may be generated based on the vector information of the first organic polarized object 503 obtained from the captured image using suitable methods. The training data set 520 may be determined based on transformations (e.g., skewing, rotating) of the data table of vectors 516. In one or more embodiments, the training data set 520 may be composed of the data table of vectors 516 associated with one or more organic polarized objects.

FIG. 5C is a flow chart illustrating a process of comparing data of the second organic polarized object 505 with the training data set 520 containing the necessary vector information on the rotation and scaling of data table of vectors 516 to identify if the second organic polarized object 505 possesses the desirable shape and/or size as specified in the training data set, according to one or more embodiments. Aforementioned process may be repeated for other organic polarized objects of interest. The images of the organic polarized objects of interest may be captured through the image capture device 120 provided thereof. The images may be processed by the data processing system (e.g. computer 138). In one or more embodiments, in operation 532, the training data set 520 may be used for casting votes for determining a center of the second organic polarized object 505. The data table of vectors 516 may be rotated, scaled and voting process may be performed. The vote counts for each rotation and scaling may be compared to determine the orientation, size, shape, and location of the organic polarized objects. A particular orientation, size, and/or location for which highest vote counts are obtained is selected. In one or more embodiments, if the highest vote count generated above is a specified threshold, then the second organic polarized object 505 is considered to be identified and/or is chosen for placement in operation 534.

Furthermore, if there is no substantial match in information between the second organic polarized object 505 and the information in the data table of vectors 516 of the first organic polarized object 503, then in operation 536, it may be determined whether all rotations and scaling of data table of vectors 516 is performed (e.g., by comparing vote count information obtained at each rotation and scaling of organic polarized object with the data table of vectors 516 of the first organic polarized object 503). Furthermore, if it is determined that all rotations and scales of the data table of vectors 516 are checked and there is no substantial match between the second organic polarized object 505 and the first organic polarized object 503, then in operation 538, the second organic polarized object 505 may be rejected. In one or more embodiments, in operation 540, rotation and scaling operation may be continued. Further, operation 532 may be initiated to determine a match and the process is continued until the organic polarized object is matched with the first organic polarized object 503 or the organic polarized object is rejected for not matching.

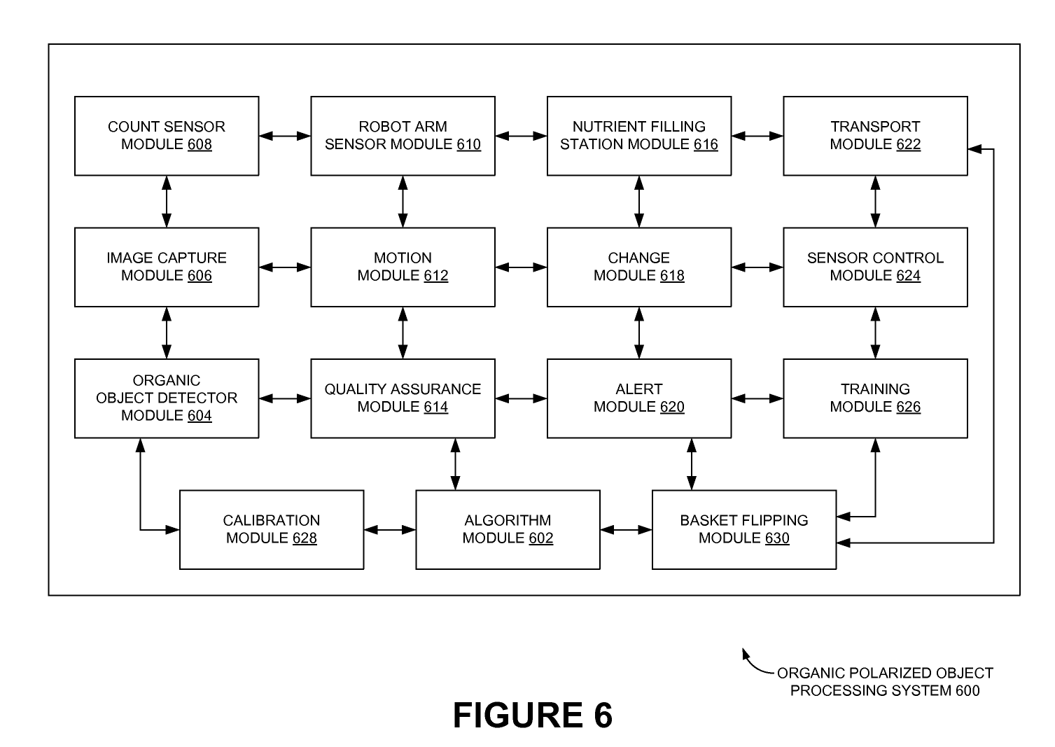

FIG. 6 is a block diagram illustrating an organic polarized object processing system 600, in accordance with one or more embodiments. The organic polarized object processing system 600 includes an algorithm module 602, an organic object detector module 604, an image capture module 606, a count sensor module 608, a robotic end effector sensor module 610, a motion module 612, a quality assurance module 614, a nutrient filling station module 616, a change module 618, an alert module 620, a transport module 622, a sensor control module 624, a training module 626, a calibration module 628, and a basket flipping module 630. In one or more embodiments, the algorithm module 602 includes an algorithm to perform one or more functions including, but not limited to regulating one or more operations of the organic object detector module 604, the image capture module 606, the count sensor module 608, the robotic end effector sensor module 610, the motion module 612, the quality assurance module 614, the nutrient filling station module 616, the change module 618, the alert module 620, the transport module 622, the sensor control module 624, and the training module 626. In one or more embodiments, the organic object detector module 604 may detect an organic polarized object of a desired shape, size, location and/or orientation from among multiple organic polarized objects. The organic object detector module 604 may coordinate with the image capture module 606 to perform the detection. In one or more embodiments, the image capture module 606 operatively couples one or more image capture devices to the organic object detector module 604.

In one or more embodiments, image capture module 606 also may control the functioning of the image capture devices (e.g. image capture device 120). The count sensor module 608 may coordinate with a sensor coupled to the robotic end effector and maintain a count of the number of organic polarized objects arriving from organic polarized object storage and update a database every time a new organic polarized object arrives. In one or more embodiments, the robotic end effector sensor module 610 may sense the various positions and movement of the robotic end effector 134. The motion module 612 regulates the movement of the robotic end effector 134 to automate organizing of the organic polarized objects in one or more slots of the tray 148. The motion module 612 may also regulate the movement of one or more parts of the robotic end effector 134, including, for example, elbow joint, a first elongated extension 136A, and a second elongated extension 136B. The motion module 612 coordinates with the robotic end effector sensor module 610 to regulate the movement of the robotic end effector 134.

In one or more embodiments, a quality assurance module 614 maintains uniformity of the organic polarized objects in the slots of the tray 148 and also controls the functioning of various modules to maintain uniformity and quality. The uniformity may be in terms of one or more of a number of organic polarized objects per tray, the quality of the organic polarized objects in the tray, a permissible amount of size and shape variation from a predetermined size and shape of the organic polarized objects, and an order of organizing the organic polarized objects in the tray. The nutrient filling station module 616 may control one or more functionalities of a nutrient filling station 151 including, but not limited to, mixing nutrients in a required proportion, transferring the nutrient mixture 162 to a nutrient bin 343, controlling the pouring of the nutrient mixture 162 into the basket 150 containing the filled tray 346, adjusting the position of the basket below the nutrient bin 343, and the like. The change module 618 may monitor that the tray 148 has reached a maximum capacity and to prompt a change for another empty tray.

In one or more embodiments, the alert module 620 alerts the change module to prompt when the tray 148 reaches a maximum capacity. The transport module 622 may control transporting the trays, the baskets, and/or the organic polarized objects on the conveyor belt 160. In one or more embodiments, the calibration module 628 may align coordinate systems of an image capture device (e.g. image capture device 120) and/or the robotic end effector. The basket flipping module 630 may communicate with the transport module 622 to coordinate basket flipping. In one or more embodiments, the basket flipping module 630 may also be configured to control and/or coordinate removal of the tray 148 after flipping the basket 150 over. The sensor control module 624 may control one or more sensors (e.g. sensor 336) coupled to the robotic end effector 134 and the nutrient filling station 151 and coordinates with various modules. The training module 626 may create and maintain a training data set by coordinating with the image capture module 606.

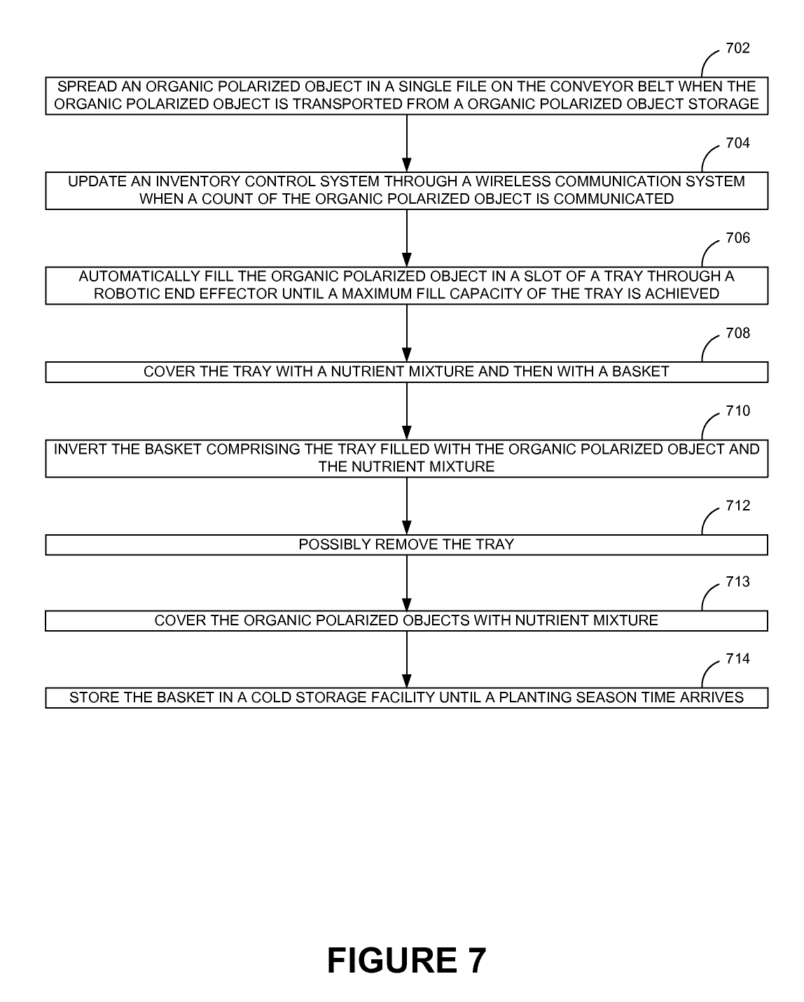

FIG. 7 is a process flow illustrating a method of automated organic polarized object organization, in accordance with one or more embodiments. As used herein, the term “organic polarized object” refers to any organic object of a regular or an irregular shape and form, having a proximal end and a distal end, and hence an orientation. Examples of the organic polarized object include, but are not limited to, a seed, a plant bulb, a resting stage of a seed plant, and a sapling. The organic polarized object may be positioned through a robotic end effector. As used herein, the term organization refers to positioning one or more organic polarized objects in a predetermined orientation and/or at a predetermined location.

In one or more embodiments, in operation 702, an organic polarized object may be spread in a single file on the conveyor belt when the organic polarized object may be transported from an organic polarized object storage. In one or more embodiments, in operation 704, an inventory control system may be updated through a wireless communication system when a count of the organic polarized object may be communicated. Examples of the wireless communication system includes, but is not limited to a Bluetooth, a Zigbee, a WiFi, a WiMax, a power over ethernet (POE), and a Wibree.

In one or more embodiments, in operation 706, the organic polarized object may be automatically filled in a slot of a tray or affixed to pins in the tray through a robotic end effector until a maximum fill capacity of the tray may be achieved. The tray may be made of one or more of a biodegradable material, a plastic material, and a reusable material. The slot may be of a specific shape to receive a first end of the organic polarized object in the slot before a second end of the organic polarized object, such that the first end of the organic polarized object may be oriented towards a narrow base of the slot and the second end may be oriented towards a broad opening of the slot.

In one or more embodiments, in operation 708, the tray may be covered with a nutrient mixture and later with a basket. In one or more embodiments, personnel may be updated about the status of an inventory item. The inventory item includes, but is not limited to the organic polarized object, the nutrient mixture, the tray and the basket. Updating personnel may be conducted via a wired/wireless communication, including, for example, through a cell phone, a PDA and/or a computer.

In one or more embodiments, in operation 710, the basket comprising the tray filled with the organic polarized object and the nutrient mixture may be inverted/flipped so that the organic polarized objects are in the correct orientation for growing. In one or more embodiments, in operation 712, the tray may be removed. In one or more embodiments, in operation 713, the organic polarized objects may be covered with the nutrient mixture while in the basket.

In one or more embodiments, the basket containing the organic polarized objects with the nutrient mixture may be stacked in a vertical form and/or a horizontal form on a platform in a cold storage facility for a length of time. In one or more embodiments, the stacked basket may be transported to a growing area. In one or more embodiments, in operation 714, the basket and/or the basket stack may be stored in the cold storage facility until a planting season time arrives.

In one or more embodiments, the organic polarized objects not selected by the robotic end effector for placement in the slot of the tray may be recycled. In one or more embodiments, a hydroponic technology may be used to grow the organic polarized objects. As used herein the term hydroponics refers to a method of growing plants without soil. In these embodiments one or more essential nutrients may be introduced to the organic polarized objects through fluids (e.g., water) in the place of soil. Also, in these embodiments, the tray may contain an array of sharp pins and the robotic end effector may stick the organic polarized objects to the sharp pins. The trays may then be positioned in a liquid (e.g., water) to allow the organic polarized objects to grow when submerged in the liquid.

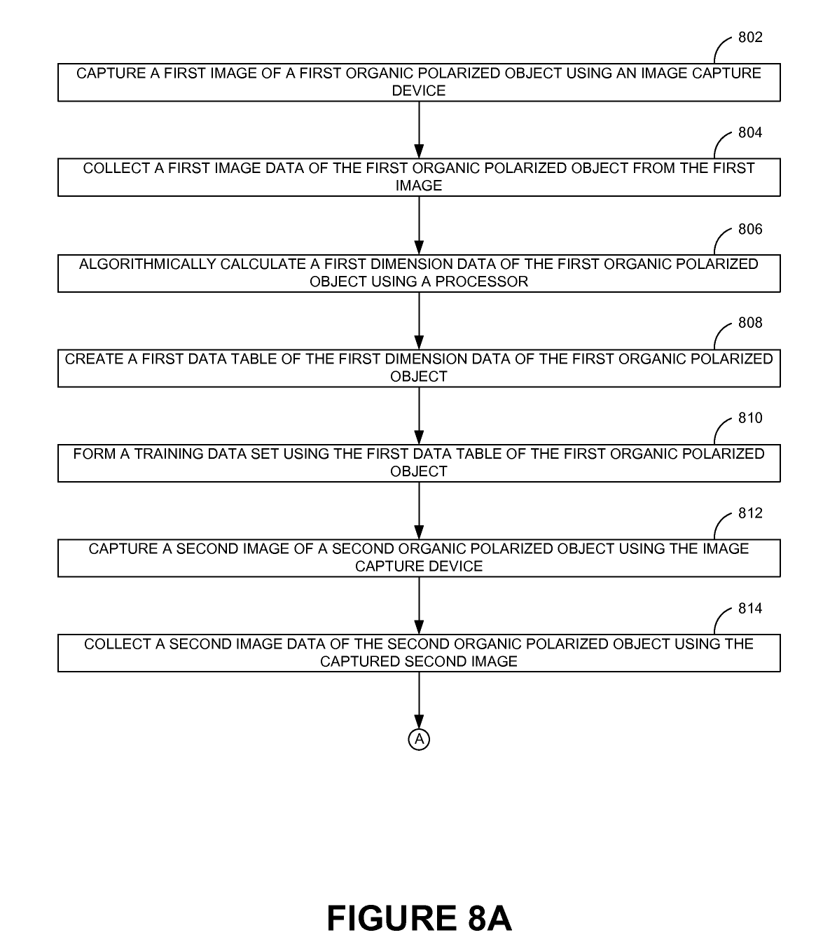

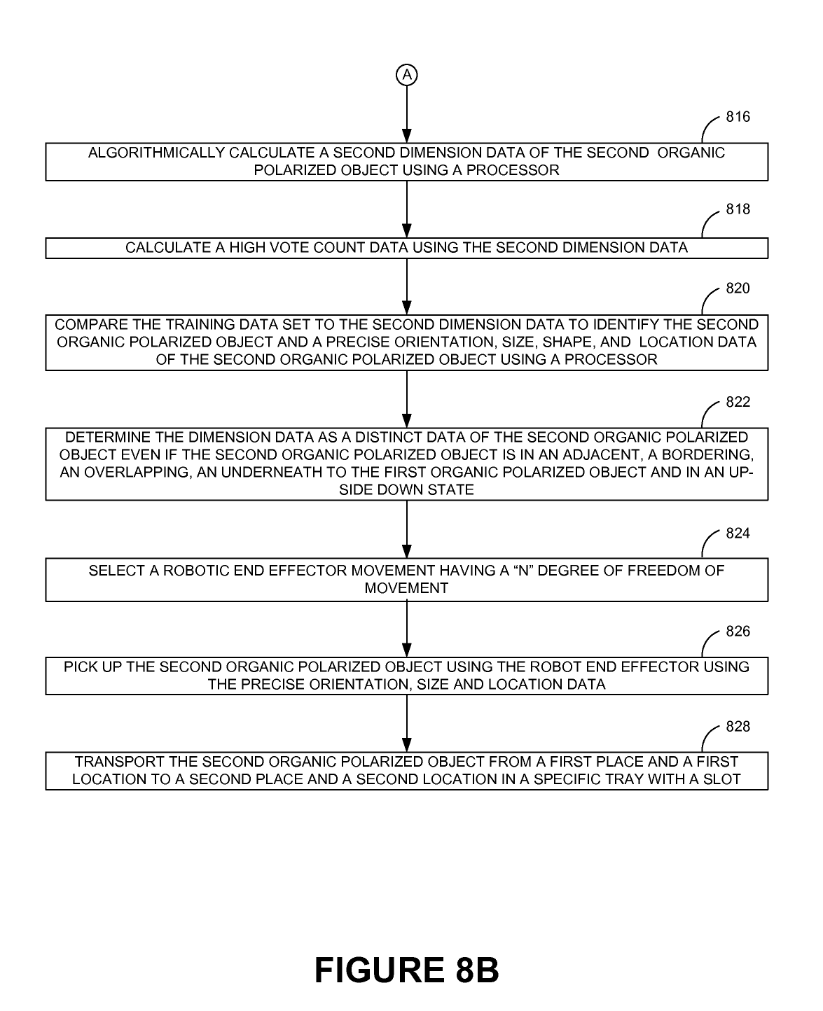

FIGS. 8A-8B show a process flow illustrating a vision based method of automated organic polarized object organization, in accordance with one or more embodiments. In one or more embodiments a robotic end effector may be trained to automatically organize one or more organic polarized objects using a training data set. In order to form the training data set, in one or more embodiments, in operation 802, a first image of a first organic polarized object may be captured using an image capture device. The image capture device may include, but is not limited to, a digital camera, a video camera, a probe, an optical device, an infra-red device, a biosensor, a color sensor, a heat sensor, a water sensor, and a laser device. In one or more embodiments, in operation 804, a first image data of the first organic polarized object may be collected from the first image.

In one or more embodiments, in operation 806, the first dimension data of the first organic polarized object may be algorithmically calculated using a processor. The first dimension data includes, but is not limited to, one or more of a width, a depth, a length, a distance, an intensity, a curvature, a surface area, a volume, a narrow field, a broad field, center, edges and an angle. In one or more embodiments, in operation 808, first data table of the first dimension data of the first organic polarized object may be created. In one or more embodiments, in operation 810, a training data set may be formed by transforming (e.g., skewing, rotating) the first data table of the first organic polarized object.

In one or more embodiments, in operation 812, a second image of a second organic polarized object may be captured using the image capture device. In one or more embodiments, in operation 814, a second image data of the second organic polarized object may be collected using the captured second image. In one or more embodiments, in operation 816, a second dimension data of the second organic polarized object may be algorithmically calculated using the second image data through a processor. The second dimension data includes, but is not limited to, one or more of a width, a depth, a length, a distance, an intensity, a curvature, a surface area, a volume, a narrow field, a broad field, edges, center and an angle. In one or more embodiments, in operation 818, a high vote count data may be calculated based on the second dimension data and the training data.

In one or more embodiments, in operation 820, a training data set may be compared to the second dimension data to identify the second organic polarized object and/or a precise location, orientation, size, and/or shape data of the second organic polarized object using a processor. In some embodiments, one or more feature extraction techniques including, but not limited to a generalized Hough transform may be used for comparison and/or identification.

In one or more embodiments, in operation 822, a dimension data may be determined as a distinct data of the second organic polarized object even if the second organic polarized object may be in one or more of an adjacent, a bordering, overlapping, underneath the first organic polarized object and in an up-side down state. In one or more embodiments, in operation 824, a robotic end effector movement having “n” degrees of freedom of movement may be selected. The “n” degrees of freedom of movement includes, but is not limited to, a moving up and down in heaving, a moving left and right in swaying, a moving forward and backward in surging, a tilting forward and backward in pitching, a turning left and right in yawing, a full axis motion in 360 degree rotation, a tilting side to side in rolling, and a movement along one or more of x, y, and z coordinate axes. In one or more embodiments, in operation 826, the second organic polarized object may be picked up using the robot end effector using the precise location, size, and/or orientation data. In one or more embodiments, in operation 828, a second organic polarized object may be transported from a first place and a first orientation to a second place and a second orientation in a specific tray with a slot.

Although the present embodiments have been described with reference to specific example embodiments, it will be evident that various modifications and changes may be made to these embodiments without departing from the broader spirit and scope of the various embodiments. For example, the organic polarized objects may be grown in liquid on a pin tray, where the robotic end effector may force the organic polarized objects onto the tray pins in the correct orientation for growing.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words not of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

What is claimed is:

1. A method, comprising:
spreading an organic polarized object in a single file on the conveyor belt when the organic polarized object is transported from an organic polarized object storage;
updating an inventory control system through a wireless communication system when a count of the organic polarized object is communicated;
automatically filling the organic polarized object in a slot of a tray through a robotic end effector until a maximum fill capacity of the tray is achieved, wherein the slot is of a specific shape to receive a first end of the organic polarized object in the slot before a second end of the organic polarized object, such that the first end of the organic polarized object is oriented towards a narrow base of the slot and the second end is oriented towards a broad opening of the slot; and
partially covering the tray with nutrient mixture and a basket, flipping the tray/basket over to orient the organic polarized objects for growing and possibly removing the tray and adding more nutrient mixture to the organic polarized objects in the basket.

2. The method of claim 1, further comprising:
inverting the basket containing the tray filled with the organic polarized objects and the nutrient mixture;
moving the basket to a nutrient filing station;
filling the basket containing the tray filled with organic polarized objects with the nutrient mixture; and
storing the basket in a cold storage facility until a planting season time arrives.

3. The method of claim 1, wherein the tray is made of at least one of a biodegradable material, a plastic material, a reusable material, and an array of sharp pins for holding the organic polarized objects.

4. The method of claim 1, wherein the wireless communication system is at least one of a Bluetooth, a Zigbee, a WiFi, a WiMax, a PoE, and a Wibree.

5. The method of claim 1, further comprising:
updating personnel about the status of an inventory item, wherein the inventory item is at least one of the organic polarized object, the nutrient mixture, the tray and the basket.

6. A method of claim 5, further comprising:
calibrating an image capture device with a robotic end effector;
capturing a first image of a first organic polarized object using an image capture device;
collecting a first image data of the first organic polarized object from the first image;
algorithmically calculating a first dimension data of the first organic polarized object using a processor, wherein the first dimension data is at least one of a width, a depth, a length, a distance, an intensity, a curvature, a surface area, a volume, a narrow field, a broad field, center, edges and an angle;
creating a first data table using the first dimension data of the first organic polarized object; and
forming a training data set by transforming the first data table of the first organic polarized object.

7. The method of claim 6, further comprising:
capturing a second image of a second organic polarized object using the image capture device;
collecting a second image data of the second organic polarized object using the captured second image;
algorithmically calculating a second dimension data of the second organic polarized object using a processor, wherein the second dimension data is at least one of a width, a depth, a length, a distance, an intensity, a curvature, a surface area, a volume, a narrow field, a broad field, edges, center and an angle;
calculating a high vote count data using the second image data and the training data;
comparing the training data set to the second dimension data to identify at least one of a precise location, orientation and size data of the second organic polarized object using a processor;
determining the dimension data as a distinct data of the second organic polarized object even if the second organic polarized object is in an at least one of an adjacent, a bordering, an overlapping, an underneath to the first organic polarized object and in an up-side down state;
selecting a robot arm movement having a “n” degree of freedom of movement;
picking up the second organic polarized object using the robot arm using the precise location, orientation and size data;
transporting the second organic polarized object from a first place and a first orientation to a second place and a second orientation in a specific tray with a slot and/or sharp pins; and
providing the slot in a specific shape to receive a first end of the second organic polarized object into the slot before a second end of the second organic polarized object, such that the first end of the second organic polarized object is oriented towards a narrow base of the slot and the second end is oriented towards a broad opening of the slot.

8. The method of claim 1, further comprising:
stacking the basket containing the tray filled with organic polarized objects with the nutrient mixture in at least one of a vertical form and a horizontal form on a platform to be transported to cold storage facility for a length of time;
transporting the stacked basket to a growing area; and
sowing the organic polarized object in a compatible growing media.

9. The method of claim 8, further comprising:
recycling the organic polarized object not selected by the robotic end effector for placement in the slot of the tray.

10. An apparatus, comprising:
an organic polarized object sorter machine to sort the organic polarized object in a single file on a conveyor belt;
the conveyor belt to transport the organic polarized object to a robotic end effector to place the organic polarized object into a slot in a tray;
an image capture device to record at least one of a first image of a first organic polarized object and a second image of a second organic polarized object;
a data storage device to store a data set from the image capture device after the recording of the image;
a processor to calculate “n” degrees of freedom movement for the robotic end effector using a training data set;
a tray with a plurality of sites to hold the second organic polarized object at a specific site; and
a signal device to indicate that the tray has reached a maximum capacity and to prompt a change for another empty tray.

11. The apparatus of claim 10, wherein the robotic end effector controlled by pneumatic cylinders attached to a first elongated extension and a second elongated extension to hold the second organic polarized object, wherein the first elongated extension and the second elongated extension having a sensor device to perform at least one or sensing the presence of an organic polarized object and controlling at least one of a closing and a opening of the first elongated extension and the second elongated extension, and wherein a software to control the robotic end effector and “n” degree of freedom movement for the robotic end effector.

12. The apparatus of claim 10, wherein the sensor device on the first elongated extension and the second elongated extension is at least one of a capacitive sensor, a resistive sensor and an inductive sensor.

13. The apparatus of claim 10, wherein the image capture device is at least one of an infra-red device, a laser device, a camera and/or cameras, a biosensor, a color sensor, a heat sensor and a water sensor.

14. The apparatus of claim 10, wherein the “n” degrees of freedom of movement is at least one of a moving up and down in heaving, a moving left and right in swaying, a moving forward and backward in surging, a tilting forward and backward in pitching, a turning left and right in yawing, a full axis motion in 360 degree rotation, a tilting side to side in rolling and a movement along at least one of x, y, and z coordinate axes..

15. The apparatus of claim 10, further comprising:
a processor to algorithmically calculate a dimension data from the first image and the second image, wherein the dimension data is at least one of a width, a depth, a length, a distance, an intensity, a curvature, a surface area, a volume, a narrow field, a broad field center, edges and an angle.

16. The apparatus of claim 10, wherein the tray is a part of a large automated assembly system.

17. The apparatus of claim 10, further comprising:
a device to flip a basket covering the tray filled with organic polarized objects;
a nutrient mixture filing station to fully fill the basket that contains the organic polarized objects; and
a fill station sensor that communicates through a wireless communication system at least one of a level of nutrient mixture in the station, change of the basket, and a count for an inventory control system.

18. The apparatus of claim 17, wherein the wireless communication system is designed with at least one of a Bluetooth, a Zigbee, a WiFi, a WiMax, a PoE, and a Wibree interface.

19. The apparatus of claim 10, wherein a communication to personnel is conducted through at least one of a cell phone, a PDA and a computer.

20. The apparatus of claim 10, wherein the tray is made of at least one of a biodegradable material, a plastic material, a reusable material and/or consists of an array of spikes to hold the organic polarized objects in place.
